(19) United States
(12) Patent Application Publication
(10) Pub. No.: US 2015/0006814 A1
(43) Pub. Date: Jan. 1, 2015

(54) DYNAMIC RAID CONTROLLER POWER MANAGEMENT

(71) Applicant: Western Digital Technologies, Inc., Irvine, CA (US)

(72) Inventors: SAN A. PHONG, CERRITOS, CA (US); BARRY L. KLEIN, TRABUCO CANYON, CA (US); JOHN E. MARONEY, IRVINE, CA (US)

(73) Assignee: Western Digital Technologies, Inc., Irvine, CA (US)

(21) Appl. No.: 13/959,887

(22) Filed: Aug. 6, 2013

Related U.S. Application Data
(60) Provisional application No. 61/840,638, filed on Jun. 28, 2013.

(51) Int. Cl. G06F 3/06

(52) U.S. Cl. CPC G06F 3/0625; G06F 3/0689; G06F 3/0653
USPC 711/114

(57) ABSTRACT

A method for reducing power consumed by a storage array controller in a storage array that comprises a plurality of physical communication interfaces such as PHYs. The method may comprise monitoring each of the plurality of physical communication interfaces. For each of the plurality of physical communication interfaces, it may be determine whether a data storage device is coupled thereto and each physical communication interface to which a data storage device is not coupled may be turned off to thereby reduce power dissipation in the controller and reduce a temperature thereof.

### CROSS-REFERENCE TO RELATED APPLICATIONS

This application claims priority to provisional U.S. Patent Application Ser. No. 61/840,638 (Atty. Docket No. T6697.P), filed on Jun. 28, 2013, which is hereby incorporated by reference it its entirety.

### BACKGROUND

Small form factor file servers have challenging air flow and thermal management demands, as a great many heat-generating devices are placed within a small volume. One of the key challenges in the design and operation of such small form factor file servers is the management of electrical power and the resultant thermal behavior, across the various operational modes thereof.

### BRIEF DESCRIPTION OF THE DRAWINGS

FIG. 1 is a block diagram of a Redundant Array of Independent Disks (RAID) system, according to one embodiment.

FIG. 2 is a flowchart of a method for reducing power consumed by a storage array controller in a storage array, according to one embodiment.

### DETAILED DESCRIPTION

One embodiment provides data storage device detection and controller power management in a storage system, resulting in reduced power requirements, improved system thermal features, and lower fan noise. Indeed, one embodiment is a method for reducing power consumed by a storage array controller in a storage array, the storage array controller comprising a plurality of physical communication interfaces. The method may comprise monitoring each of the plurality of physical communication interfaces. For each of the plurality of physical communication interfaces, it may be determined whether a data storage device is coupled thereto. Each physical communication interface to which a data storage device is not coupled or that is coupled to a data storage device that has been turned off may be individually and independently turned off. This reduces power dissipation in the controller and the temperature thereof.

One embodiment of a storage array may comprise a controller board comprising a processor, a backplane coupled to the controller board, the backplane comprising a micro-controller. The storage array may also comprise a storage array controller comprising a plurality of physical communication interfaces and a plurality of data storage devices, each coupled to one of the plurality of physical communication interfaces. According to one embodiment, the storage array controller may be configured to detect the presence of a data storage device on each of the physical communication interfaces and to disable the physical communication interfaces on which a data storage device is not detected or to which is coupled a data storage device that has been turned off.

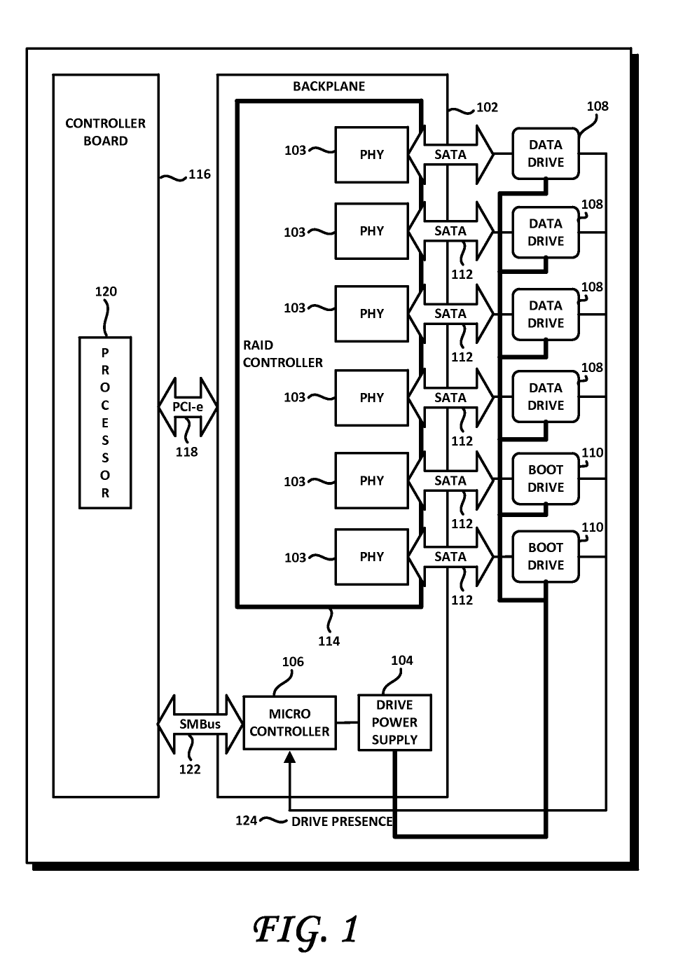

FIG. 1 is a block diagram of a Redundant Array of Independent Disks (RAID) system, according to one embodiment. As shown, a backplane 102 may comprise one or more drive power supplies 104 and a microcontroller 106. The backplane 102 may also comprise a storage array (e.g., RAID) controller 114 that may be coupled to one or more data storage devices 108 and to one or more boot data storage devices 110, over physical communication interfaces (PHY) 103. The data storage devices 108, 110 may comprise hard disk drives, hybrid disk drives and solid state storage device. The RAID controller 114 may be addressed by a processor 120 on a controller board 116 via, for example, a PCIe protocol 118 using, in one exemplary implementation, a PCIe×8 lane interface. The RAID controller 114 may support, for example, eight (8) (e.g., SATA) physical communication interfaces 103. The physical communication interfaces 103 are configured according to a communication protocol. In the implementation shown in FIG. 1, the communication protocol may comprise the Serial Advance technology Attachment (SATA) protocol.

The microcontroller 106 (which may be, in one implementation, a 16-bit TI MSP430 standalone microcontroller) on the backplane 102 may be configured to monitor a drive presence signal 124 (which is indicative of whether a drive is present on each of the physical communication interfaces) using, for example, a data storage device-grounded pin on each SATA interface. This microcontroller 106 may be configured to communicate with the processor 120 on the controller board 116 via a bus 122 (which may be configured, for example, as an SMBus/12C bus) to detect and report the presence of each of the data drives 108 and of each of the boot drives 110 (in one implementation, each a 2.5″ form factor data storage device such as a hard disk drive (HDD)). The microcontroller 106 may be coupled to and control a drive power supply 104. The drive power supply 104 may be coupled to each of the data storage devices 108, 110 and may be configured to selectively shut off and turn on any of the drives 108, 110. According to one embodiment, the microcontroller 106 may be configured to control the drive power supply 104 to selectively turn off and turn on one or more supply voltages in each of the data storage devices 108, 110. For example, each of the data storage devices may require, for example, both a 12 volt supply to power the drive's spindle motor and a 5 volt supply for the drive controller and associated electronic devices on the drive's printed circuit board.

Storage array controllers such as RAID controllers may comprise a greater number (e.g., eight) of physical communication interfaces than are required in some implementations. For example, as shown in FIG. 1, a storage server may comprise two boot drives 110 and four data drives 108 which, in the case of an eight physical communication interface controller 114, leaves two unused physical communication interfaces 103. The storage array controller 114 (e.g., manufactured by Marvell Semiconductor, Inc. in one implementation) may not be configured to support being placed in a standby, low power-dissipating state, even if held in continual reset. Indeed, all (e.g., SATA) physical communication interfaces 103 in a storage array controller 114 of a storage server may be continually powered up, even though all physical communication interfaces 103 may not be in use (i.e., no data storage devices 108, 110 are coupled thereto or are shut down) at any given time.

The storage array controller 114, for example, may draw about 5 Watts (W) of power—even in a standby state (in fact, the controller may not even have a standby power reduction mode). This power consumption results in the chip temperature at the storage array controller 114 rising to a high level (e.g., above 90° C.) in standby, which may cause the one or more fans in the storage array enclosure to be driven faster to shunt the generated heat away from the storage array controller 114. Increasing the fan speed, however, draws more power and may result in objectionable fan noise. Ultimately, the increasing chip temperature on the storage array controller 114 may lead to thermal shutdown, due to insufficient airflow through the heat sink coupled to the storage array controller 114. Such a thermal shutdown, moreover, often may not be averted by driving the fan(s) harder, as the highest fan speed may be lower than that necessary to dissipate the generated heat. When such a system wakes from standby, it is often non-functional as the storage array controller 114 has shut down because it is still too hot to operate safely.

One embodiment is a method for a controller to reduce power dissipation in a server by selectively enabling and disabling one or more of the (e.g., SAS/SATA) physical communication interfaces 103 (shown as physical layer PHYs in FIG. 1 (e.g., a receive pair and a transmit pair of conductors for each interface 103)) of the storage array controller 114 to save on overall chip power dissipation, depending on whether a drive is present on the physical communication interfaces 103. According to one embodiment, the selective enabling and disabling may be based on a physical drive presence detect signal 124 received via a drive connector coupled to each of the data storage devices 108, 110 and the storage array controller 114 sensing a (e.g., SAS/SATA) drive link present. For example, this selective enabling and disabling may be based on a physical drive presence detect signal 124 received via a drive connector coupled to each of the data storage devices 108, 110 and the storage array controller 114 sensing a (e.g., SAS/SATA) drive link present within a set timeout period after power is applied to the drive. Indeed, the storage array controller 114 may be configured to enable each physical communication interface 103 to be shut down individually and independently at any time.

For example, if the storage array controller 114 has two unused physical communication interfaces 103, these unused physical communication interfaces 103 may be shut down, to thereby reduce overall chip power by, in one implementation, approximately 0.625 W, and correspondingly reducing chip temperature. This (optionally together with a more robust heatsink) may bring chip temperatures down to an acceptable level, given a fan speed compatible with standby mode.

According to one embodiment, if no drive presence signal 124 is accessible, the storage array controller 114 may be configured to periodically and, in one embodiment, sequentially, enable its physical communication interfaces 103, to poll for the presence of a link within a set timeout period, and then disable the link of any physical communication interfaces 103 to which a data storage device 108, 110 is not coupled, to thereby conserve chip power and reduce heat dissipation. According to one embodiment, if data storage devices are removed or replaced while the storage array is powered or prior to a reset, the microcontroller 106 may be configured to dynamically respond to missing data storage devices 108, 110, send a message back to the processor 120 of the controller board 116 via the (e.g., SMBus/I2C) bus 122 to turn off the corresponding physical communication interface(s) and manage the physical communication interface power accordingly.

According to one embodiment, for data storage arrays that do not have microcontroller 106 available, the state of the drive presence signal 124 may be interpreted by the storage array controller 114 via a general purpose input output port (GPIO). This port may be programmed as an input and to generate an interrupt to the processor 120 of the controller board 116 when the state of the drive-presence signal 124 changes. Moreover the storage array may be configured to reduce the speed of one or more fans when one or more physical communication interfaces 103 are no longer in use. In turn, this lower speed reduces the audible noise from the storage array.

Significantly, embodiments enable dynamic optimized power for a given data storage device configuration, a lower thermal signature for the storage array controller 114 and an improved fan mean time before failure (MTBF).

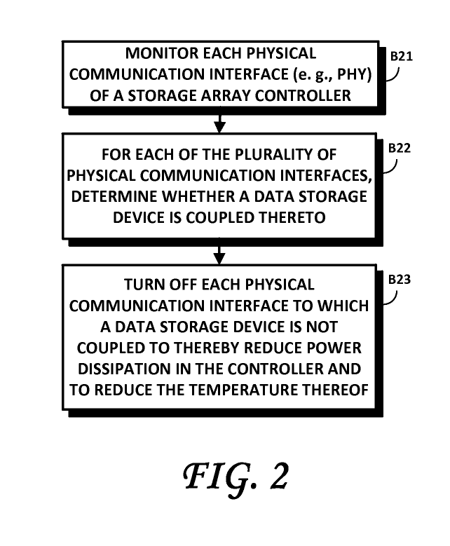

FIG. 2 is a flowchart of a method for reducing power consumed by a storage array controller in a storage array, the storage array controller comprising a plurality of physical communication interfaces, according to one embodiment. As shown therein, Block B21 calls for each physical communication interfaces of a storage array controller to be monitored. In Block B22, for each of the monitored physical communication interfaces, it is determined whether a data storage device (e.g., a HDD) is coupled thereto. Lastly, as shown at B23, each physical communication interface of the storage array controller to which a data storage device is not coupled may be turned off, to reduce power dissipation in the storage array controller and to reduce the temperature thereof.

According to one embodiment, the monitoring of Block B21 may be carried out within a predetermined period after power is applied to the storage array. The determination of whether a data storage device is coupled to each of the physical communication interfaces 103 may include polling one or more of the physical communication interfaces 103 to determine whether a data storage device 108, 110 is coupled to its corresponding physical communication interface 103. According to one embodiment, such polling may be carried out periodically. The physical communication interfaces 103 may be polled in any order. According to one embodiment, the physical communication interfaces 103 may be polled sequentially.

When a previously turned-off physical communication interface is turned back on, it may be determined whether a data storage device such as shown at 108, 110 is coupled to the just-turned on physical communication interface 103.

One embodiment, therefore, may comprise responding to a data storage device 108, 110 that is uncoupled from a physical communication interface of the controller 114 or turned off by turning off the physical communication interface 103 from which the data storage device 108, 110 was uncoupled or to which a data storage device 108, 110 that has been turned off is coupled.

One embodiment is a storage array controller (configured, for example, as an integrated circuit) that is configured to control an array of data storage devices. Such a storage array controller, shown at 114 in FIG. 1, may comprise a plurality of physical communication interfaces 103, each of which may be configured to couple the storage array controller 114 to a respective data storage device 108, 110. In use and according to one embodiment, the storage array controller may be further configured (in firmware, for example) to monitor each of the plurality of physical communication interfaces 103, determine whether a data storage device 108, 110 is coupled to each of the plurality of physical communication interfaces 103. This determination whether a data storage device 108, 110 is coupled to each of the plurality of physical communication interfaces 103 may be reported to the micro-controller 106 or to the processor 120. Based upon a response from the micro-controller 106 or the processor 120, the storage array controller 114 may be configured to turn off one or more physical communication interfaces to which a data storage device 108, 110 is not coupled or to which is coupled a data storage device 108, 110 that has been turned off. Doing so, according to one embodiment, reduces power dissipation in the storage array controller 114 and reduces a temperature thereof.

While certain embodiments of the disclosure have been described, these embodiments have been presented by way of example only, and are not intended to limit the scope of the disclosure. Indeed, the novel methods, devices and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A storage array, comprising:
a processor;
a storage array controller comprising a plurality of physical communication interfaces; and
a plurality of data storage devices, each coupled to one of the plurality of physical communication interfaces, the storage array controller being configured to detect a presence of a data storage device on each of the physical communication interfaces and to disable the physical communication interfaces on which a data storage device is not detected.

2. The storage array of claim 1, wherein the processor is coupled to a controller board and wherein the storage array controller is coupled to a backplane that is coupled to the controller board.

3. The storage array of claim 1, wherein the storage array controller is further configured to monitor a state of a drive presence signal coupled to each of the plurality of data storage devices.

4. The storage array of claim 3, wherein the storage array controller is further configured to monitor the state of the drive presence signal within a predetermined period after power is applied to the storage array.

5. The storage array of claim 1, wherein the storage array controller is further configured to poll at least one of the plurality of physical communication interfaces to determine whether a data storage device is coupled to the polled physical communication interface.

6. The storage array of claim 5, wherein the storage array controller is further configured to poll at least one of the plurality of physical communication interfaces periodically.

7. The storage array of claim 5, wherein the storage array controller is further configured to poll at least some of the plurality of physical communication interfaces sequentially.

8. The storage array of claim 1, wherein the storage array controller is further configured to turn on a previously turned off physical communication interface and determine whether a data storage device is coupled to the turned on physical communication interface.

9. The storage array of claim 1, wherein the storage array controller is further configured to respond to a data storage device that is uncoupled from its physical communication interface or turned off by turning off the physical communication interface from which the data storage device was uncoupled or to which a data storage device that has been turned off is coupled.

10. The storage array of claim 1, wherein the storage array controller is further configured to monitor a state of one or more general purpose input output (GPIO) ports.

11. The storage array of claim 10, wherein the storage array controller is further configured to monitor the state of the one or more GPIO ports by receiving an interrupt therefrom.

12. The storage array of claim 1, further comprising a power supply and a microcontroller configured to control the power supply and to selectively turn off at least one supply voltage to at least one of the plurality of data storage devices.

13. A storage array controller configured to control an array of data storage devices, the storage array controller comprising:
a plurality of physical communication interfaces, each configured to couple the storage array controller to a respective data storage device;
wherein the storage array controller is further configured to:
monitor each of the plurality of physical communication interfaces;
determine whether a data storage device is coupled to each of the plurality of physical communication interfaces; and
turn off each physical communication interface to which a data storage device is not coupled or to which is coupled a data storage device that has been turned off,
thereby reducing power dissipation in the controller and reducing a temperature thereof.

14. The storage array controller of claim 13, wherein the storage array controller is further configured to:
report whether a data storage device is coupled to each of the plurality of physical communication interfaces to a processor or microcontroller; and
turn off each physical communication interface to which a data storage device is not coupled or to which is coupled a data storage device that has been turned off, based on a response from the processor or microcontroller.

15. A method for reducing power consumed by a storage array controller in a storage array, comprising:
monitoring each of a plurality of physical communication interfaces, the storage array controller comprising the plurality of physical communication interfaces;
for each of the plurality of physical communication interfaces, determining whether a data storage device is coupled thereto; and
turning off each physical communication interface to which a data storage device is not coupled to thereby reduce power dissipation in the controller and reduce a temperature thereof.

16. The method of claim 15, wherein determining comprises monitoring a state of a drive presence signal coupled to at least some data storage devices in the storage array.

17. The method of claim 15, wherein monitoring is carried out within a predetermined period after power is applied to the storage array.

18. The method of claim 15, wherein determining comprises polling at least one of the plurality of physical communication interfaces to determine whether a data storage device is coupled to the polled physical communication interface.

19. The method of claim 18, wherein polling is carried out periodically.

20. The method of claim 19, wherein at least some of the plurality of physical communication interfaces are polled sequentially.

21. The method of claim 18, wherein polling comprised turning on a previously turned off physical communication interface and determining whether a data storage device is coupled to the turned on physical communication interface.

22. The method of claim 15, further comprising responding to a data storage device that is uncoupled from its physical communication interface or turned off by turning off the physical communication interface from which the data storage device was uncoupled or to which a data storage device that has been turned off is coupled.

23. The method of claim 15, wherein monitoring comprises monitoring a state of one or more general purpose input output (GPIO) ports of the storage array controller.

24. The method of claim 23, wherein monitoring the state of the one or more GPIO ports comprises receiving an interrupt therefrom.

25. The method of claim 15, wherein at least one of the physical communication interfaces comprises a PHY.

26. The method of claim 15, wherein at least one of the plurality of physical communication interfaces is configured according to a communication protocol.

27. The method of claim 26, wherein the communication protocol comprises SATA.

28. The method of claim 15, further comprising decreasing a speed of a fan in the storage array.
